(19) United States
(12) Patent Application Publication
(10) Pub. No.: US 2015/0055057 A1
(43) Pub. Date: Feb. 26, 2015

(54) TOUCH SENSITIVE DISPLAY

(71) Applicant: Austin L. Huang, Vancouver, WA (US)

(72) Inventor: Austin L. Huang, Vancouver, WA (US)

(21) Appl. No.: 14/460,114

(22) Filed: Aug. 14, 2014

Related U.S. Application Data
(60) Provisional application No. 61/985,864, filed on Apr. 29, 2014.
(60) Provisional application No. 61/869,511, filed on Aug. 23, 2013.

(51) Int. Cl. G02F 1/1333; G02F 1/1343; G02F 1/1335

(52) U.S. Cl. CPC G02F 1/13338; G02F 1/133528; G02F 1/133602; G02F 1/13439; G02F 2001/133548
USPC 349/62; 349/96

(57) ABSTRACT

A display assembly and a touch sensitive assembly that includes a conductive linear polarizer.

### CROSS-REFERENCE TO RELATED APPLICATIONS

This application claims the benefit of U.S. Provisional Application No. 61/985,864, filed Apr. 29, 2014 and the benefit of U.S. Provisional Application No. 61/869,511, filed Aug. 23, 2013.

### TECHNICAL FIELD

The present invention relates to displays and, more particularly, to a touch screen for a liquid crystal display.

### BACKGROUND OF THE INVENTION

The local transmittance of a liquid crystal display (LCD) panel or a liquid crystal on silicon (LCOS) display can be varied to modulate the intensity of light passing from a backlit source through an area of the panel to produce a pixel that can be displayed at a variable intensity. Whether light from the source passes through the panel to an observer or is blocked is determined by the orientations of molecules of liquid crystals in a light valve.

Since liquid crystals do not emit light, a visible display requires an external light source. Some LCD panels rely on light that is reflected back toward the viewer after passing through the panel. Since the panel is not completely transparent, a substantial part of the light is absorbed during its transits of the panel and images displayed on this type of panel may be difficult to see except under the best lighting conditions. On the other hand, LCD panels used for computer displays and video screens are typically backlit with fluorescent tubes or arrays of light-emitting diodes (LEDs) that are built into the sides or back of the panel. To provide a display with a more uniform light level, light from these point or line sources is typically dispersed in a diffuser panel before impinging on the light valve that controls transmission to a viewer.

The transmittance of the light valve is controlled by an applied voltage to a layer of liquid crystals interposed between a pair of polarizers. Light from the source impinging on the first polarizer comprises electromagnetic waves vibrating in a plurality of planes. Only that portion of the light vibrating in the plane of the optical axis of a polarizer can pass through the polarizer. In an LCD the optical axes of the first and second polarizers are arranged at an angle so that light passing through the first polarizer would normally be blocked from passing through the second polarizer in the series. However, a layer of translucent liquid crystals occupies a cell gap separating the two polarizers. The physical orientation of the molecules of liquid crystal can be controlled and the plane of vibration of light transiting the columns of molecules spanning the layer can be rotated to either align or not align with the optical axes of the polarizers.

The surfaces of first and second layers of polyimide (typically a pair of stacks of glass, ITO, and polyimide) forming the walls of the cell gap are grooved so that the molecules of liquid crystal immediately adjacent to the cell gap walls will align with the grooves and, thereby, be aligned with the optical axis of the respective polarizer. Molecular forces cause adjacent liquid crystal molecules to attempt to align with their neighbors with the result that the orientation of the molecules in the column spanning the cell gap twist over the length of the column. Likewise, the plane of vibration of light transiting the column of molecules will be “twisted” from the optical axis of the first polarizer to that of the second polarizer. With the liquid crystals in this orientation, light from the source can pass through the series polarizers of the translucent panel assembly to produce a lighted area of the display surface when viewed from the front of the panel.

To vary the intensity of a pixel and create an image, a voltage, typically controlled by a thin film transistor, is applied to an electrode in an array of electrodes deposited on one wall of the cell gap. The liquid crystal molecules adjacent to the electrode are attracted by the field created by the voltage between the two plates and rotate to align with the field. As the molecules of liquid crystal are rotated by the electric field, the column of crystals is “untwisted,” and the optical axes of the crystals adjacent the cell wall are rotated out of alignment with the optical axis of the corresponding polarizer progressively reducing the local transmittance of the light valve and the intensity of the corresponding display pixel. Color LCD displays are created by varying the intensity of transmitted light for each of a plurality of primary color elements (typically, red, green, and blue) that make up a display pixel. A variety of different orientation techniques of the liquid crystal material together with typically a pair of polarizers have likewise been developed.

To provide touch sensitive capabilities for the liquid crystal display, a variety of different technologies have been developed. The touchscreen provides control through simple or multi-touch gestures by touching the screen with one or more fingers. One such technology is a resistive touchscreen that often comprises several layers including two thin transparent electrically resistive layers that are spaced apart. The outer screen that is touched includes an underside surface coating and the inner screen that is not touched includes an upper surface coating. Often one of these surface coatings has a horizontal orientation of stripes while the other surface coating has a vertical orientation of stripes. When an object, such as a finger, pressed down on the outer surface, the two layers touch to become connected at the touch point. The panel then forms a pair of voltage dividers, one axis at a time, where the position of the pressure being exerted can be determined. Unfortunately, such resistive touch panel displays tend to increase the thickness of the display, tend to increase the complexity of the display, suffer from significant “ghost” touches, and tend to decrease the brightness of the display, and can break due to excessive wearing (i.e. the ITO layer cracks from excessive bending of the sensor).

Another type of touchscreen technology is a capacitive touchscreen which often includes an insulator such as glass, coated with a transparent conductor such an indium tin oxide. As the finger touches the display, a distortion in the display's electrostatic field occurs which is measurable as a change in capacitance. The capacitive touchscreen may be configured as surface capacitance, projected capacitance, and mutual capacitance. Unfortunately, such capacitive touch panel displays tend to increase the thickness of the display, tend to increase the complexity of the display, tend to decrease the brightness of the display, and is not generally scalable due to the increase resistance of the ITO layer and the screen size increases.

Another type of touchscreen technology uses surface acoustic waves. Surface acoustic wave touchscreen uses ultrasonic waves that pass over the touchscreen panel, which when is touched, a portion of the wave is absorbed which is used to determine the position of the touch. Unfortunately, such surface acoustic wave touch panel displays tend to increase the thickness of the display, tend to increase the complexity of the display, fail to operate properly when objects are on the surface of the panel, tend to decrease the brightness of the display, and also has touch ghosting issues.

Another type of touchscreen technology uses an infrared grid. The infrared grid touchscreen uses an array of horizontal-vertical infrared light sources and photodetectors around the peripheral of the display. When touched the disruption of the infra-red signal is determined. Unfortunately, such infrared touch panel displays cannot detect two fingers if they contact the same row or column and tend to increase the thickness of the display, tend to increase the complexity of the display, and tend to decrease the brightness of the display.

It is desirable for the touch screen display be included in such a manner that it only reduces the brightness of the display in a minimal manner if at all, only increases the thickness of the display in a minimal manner if at all, while similarly only minimally increasing the complexity of the display if at all.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1. illustrates a liquid crystal display.

FIG. 2 illustrates a conductive linear polarizer.

FIG. 3 illustrates a side view and a top view of a conductive linear polarizer.

FIG. 4 illustrates a display assembly and a touch screen assembly.

FIG. 5 illustrates a display assembly and a touch screen assembly together with a wire grid polarizer.

FIG. 6 illustrates a graphical equivalent circuit for the structure illustrated in FIG. 5.

FIG. 7 illustrates an electrical element equivalent circuit for the structure illustrated in FIG. 5.

FIG. 8 illustrates another arrangement for the display including a wire grid polarizer.

FIG. 9 illustrates another arrangement for the display including a wire grid polarizer.

FIG. 10 illustrates a color filter assembly with a wire grid polarizer.

FIG. 11 illustrates different wire grid polarizer structures.

FIG. 12 illustrates a one glass architecture.

FIG. 13 illustrates another one glass architecture.

FIG. 14 illustrates another arrangement for the display including a wire grid polarizer.

FIG. 15 illustrates another arrangement for the display including a wire grid polarizer.

FIG. 16 illustrates another arrangement for the display including a wire grid polarizer.

### DETAILED DESCRIPTION OF PREFERRED EMBODIMENT

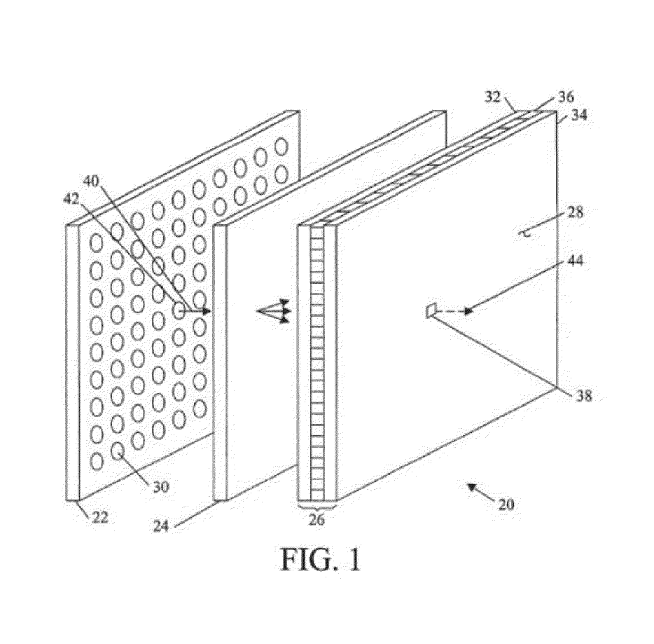

Referring to FIG. 1, a backlit display 20 comprises, generally, a backlight 22, a diffuser 24, and a light valve 26 (indicated by a bracket) that controls the transmittance of light from the backlight 22 to a user viewing an image displayed at the front of the panel 28. The light valve, typically comprising a liquid crystal apparatus, is arranged to electronically control the transmittance of light for a picture element or pixel. Since liquid crystals do not emit light, an external source of light is necessary to create a visible image. The source of light for small and inexpensive LCDs, such as those used in digital clocks or calculators, may be light that is reflected from the back surface of the panel after passing through the panel. Likewise, liquid crystal on silicon (LCOS) devices rely on light reflected from a backplane of the light valve to illuminate a display pixel. However, LCDs absorb a significant portion of the light passing through the assembly and an artificial source of light such as the backlight 22 comprising fluorescent light tubes or an array of light sources 30 (e.g., light-emitting diodes (LEDs)), or other manner of illumination, as illustrated in FIG. 1, is necessary to produce pixels of sufficient intensity for highly visible images or to illuminate the display in poor lighting conditions. There may not be a light source 30 for each pixel of the display and, therefore, the light from the point or line sources is typically dispersed by the diffuser panel 24 so that the lighting of the front surface of the panel 28 is more uniform.

Light radiating from the light sources 30 of the backlight 22 comprises electromagnetic waves vibrating in random planes. Only those light waves vibrating in the plane of a polarizer's optical axis can pass through the polarizer. The light valve 26 includes a first polarizer 32 and a second polarizer 34 having optical axes arrayed at an angle so that normally light cannot pass through the series of polarizers. Images are displayable with an LCD because local regions of a liquid crystal layer 36 interposed between the first 32 and second 34 polarizer can be electrically controlled to alter the alignment of the plane of vibration of light relative of the optical axis of a polarizer and, thereby, modulate the transmittance of local regions of the panel corresponding to individual pixels 36 in an array of display pixels.

The layer of liquid crystal molecules 36 occupies a cell gap having walls formed by opposing surfaces. The walls of the cell gap are rubbed to create microscopic grooves and the optical axis of the corresponding polarizer is aligned with the grooves. The grooves cause the layer of liquid crystal molecules adjacent to the walls of the cell gap to align with the optical axis of the associated polarizer. As a result of molecular forces, each succeeding molecule in the column of molecules spanning the cell gap will attempt to align with its neighbors. The result is a layer of liquid crystals comprising innumerable twisted columns of liquid crystal molecules that bridge the cell gap. As light 40 originating at a light source element 42 and passing through the first polarizer 32 passes through each translucent molecule of a column of liquid crystals, its plane of vibration is “twisted” so that when the light reaches the far side of the cell gap its plane of vibration will be aligned with the optical axis of the second polarizer 34. The light 44 vibrating in the plane of the optical axis of the second polarizer 34 can pass through the second polarizer to produce a lighted pixel 38 at the front surface of the display 28.

To darken the pixel 38, a voltage is applied to a spatially corresponding electrode of a rectangular array of transparent electrodes deposited on a wall of the cell gap. The resulting electric field causes molecules of the liquid crystal adjacent to the electrode to rotate toward alignment with the field. The effect is to “untwist” the column of molecules so that the plane of vibration of the light is progressively rotated away from the optical axis of the polarizer as the field strength increases and the local transmittance of the light valve 26 is reduced. As the transmittance of the light valve 26 is reduced, the pixel 38 progressively darkens until the maximum extinction of light 40 from the light source 42 is obtained. Color LCD displays are created by varying the intensity of transmitted light for each of a plurality of primary color elements (typically, red, green, and blue) elements making up a display pixel.

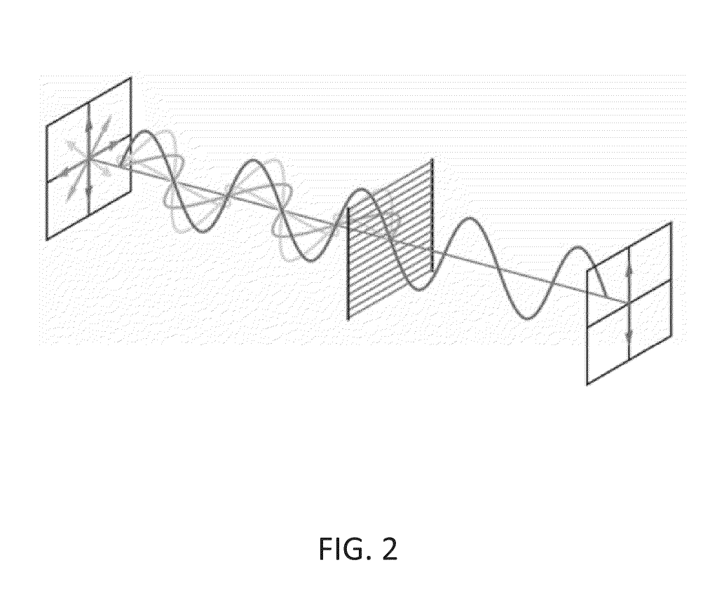

Referring to FIG. 2, one type of polarizer is a linear polarizer. One technique for implementing a linear polarizer is a wire-grid polarizer, which consists of an array of substantially parallel metallic conductive wires located substantially in a plane substantially perpendicular to the incident beam. Electromagnetic waves which have a component of their electric fields aligned parallel to the wires induce the movement of electrons along the length of the wires. Since the electrons are free to move in this direction, the polarizer behaves in a similar manner to the surface of a metal when reflecting light; and the wave is reflected backwards along the incident beam (minus a small amount of energy lost to heating (e.g., absorption) of the wire). For waves with electric fields perpendicular to the wires, the electrons cannot move very far across the width of each wire; therefore, little energy is reflected, and the incident wave is able to pass through the grid. Since electric field components parallel to the wires are reflected, the transmitted wave has an electric field in the direction perpendicular to the wires, and is thus linearly polarized. The separation distance between the wires is typically substantially less than the wavelength of the radiation, and the wire width should be a small fraction of this distance. For example, the wires may be individual wires or otherwise a patterned photolithographic metal lines. For a visible light, the metal lines are preferably on the order of 100 Nano meter spacing from one another.

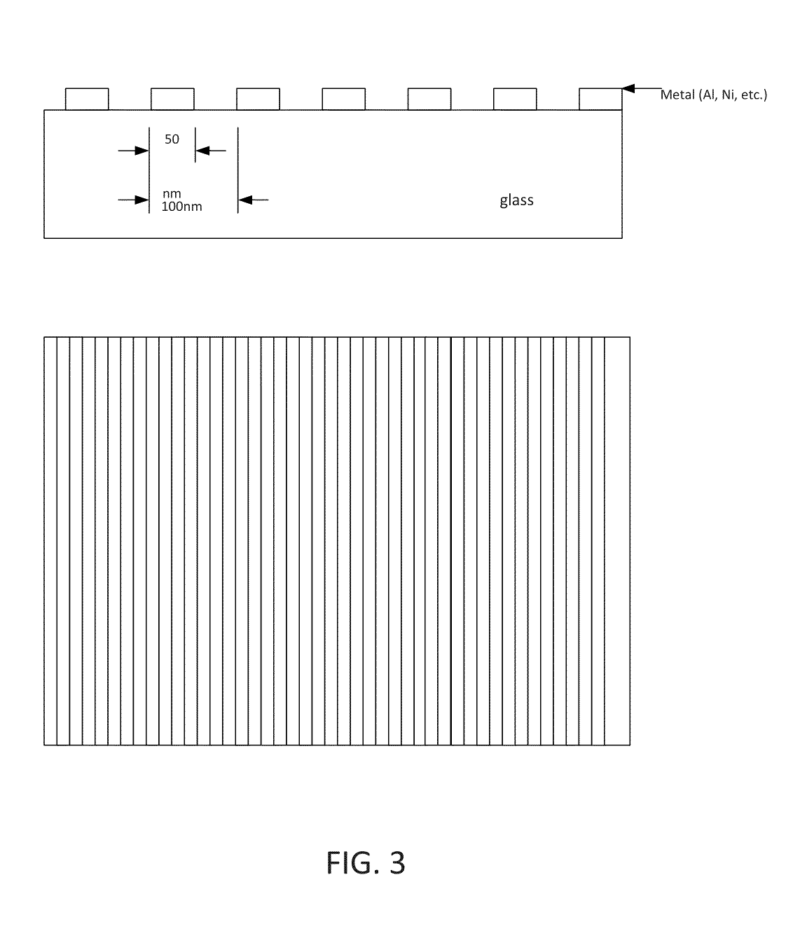

Referring to FIG. 3, an exemplary wire grid polarizer is illustrated. The polarizer has a series of parallel conductive members at evenly spaced apart locations from one another supported by an insulative substrate, such as glass. The conductive members may be any conductive material, such as for example, aluminum, silver, gold, or nickel. In some embodiments, some of the bars may be open while others are opaque. The conductive members preferably have a width of 50 nm, and preferably have a width within the range of 25 nm to 75 nm. In some cases the conductive members may have a width of generally 15 nm to generally 150 nm. The conductive members preferably have a spacing between adjacent members of 50 nm, and preferably have a spacing within the range of 25 nm to 75 nm. In some cases the conductive members have a spacing between adjacent members of 15 nm to 150 nm. The conductive members preferably have a center-to-center spacing of 100 nm, and preferably have a center-to-center spacing within the range of 50 to 150 nm. In some cases the conductive members may have a center-to-center spacing within the range of 100 nm to 225 nm; or 25 nm to 125 nm. This configuration of the wire grid polarizer tends to be suitable for the visible light spectrum (e.g., from about 400 mn to 700 nm). The height of the conductive members is preferably within the range of 120 nm to 140 nm, while may be generally within the range of 50 nm to 250 nm. The width of the conductive members and the spacing between the conductive members may be the same or different, as desired. Moreover, the width, spacing, and/or height of the conductive members may be different in different regions of the display.

Projected capacitive touch screen technology is a variant of capacitive touch technology. The projected capacitive touch screens are made up of a matrix of rows and columns of conductive material, layered on sheets of glass. This is often done either by etching a single conductive layer to form a grid pattern of electrodes, or by etching two separate, perpendicular layers of conductive material with parallel lines or tracks to form a grid. Voltage applied to this grid creates a uniform electrostatic field, which can be measured. When a conductive object, such as a finger, comes into contact with a panel, it distorts the local electrostatic field at that point. This is measurable as a change in capacitance. If a finger bridges the gap between two of the “tracks,” the charge field is further interrupted and detected by the controller. The capacitance can be changed and measured at every individual point on the grid (intersection). Software (e.g., firmware) within the display assembly or an associated device is typically used to determine the location, whether it is at an intersection or otherwise “in-between” intersecting points. Therefore, this system is able to accurately track one or more touches. Due to the top layer being glass, it is a more robust solution than less costly resistive touch technology. Additionally, unlike traditional capacitive touch technology, it is suitable for such a touch sensitive system to sense a passive stylus or gloved fingers. In general, there are two principal types of projected capacitance touch displays, namely, mutual capacitance and self-capacitance.

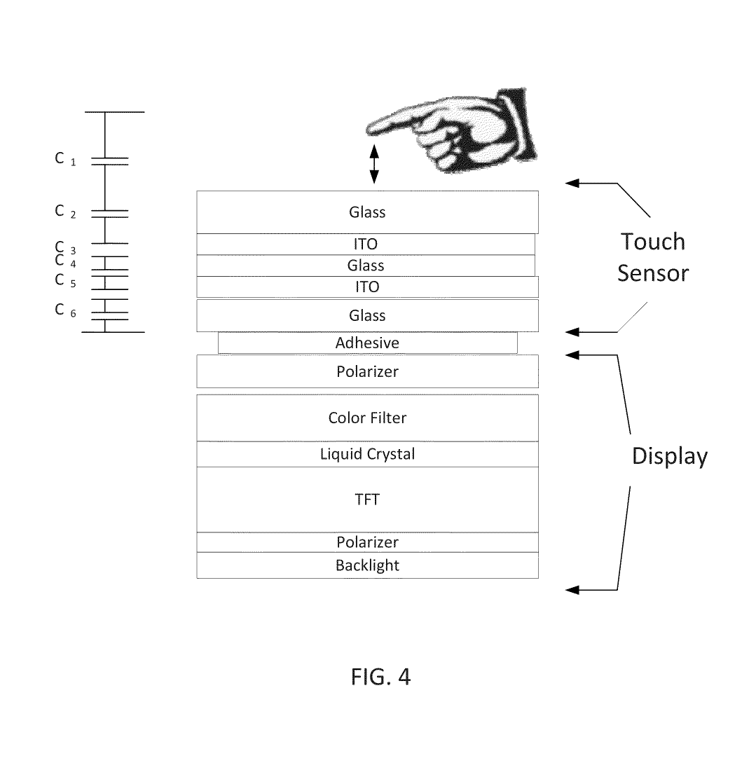

Referring to FIG. 4, a projective capacitive touch screen may include a series of components. The display itself may include a combination of a backlight, a polarizer, a thin film transistor array, a liquid crystal layer, a color filter layer, and a polarizer. The result of which is a display assembly suitable to display images. A capacitive touch screen assembly may include an insulative layer (e.g., glass layer), a conductive layer (e.g., indium tin oxide), an insulative layer (e.g., glass layer), a conductive layer (e.g., indium tin oxide), and an insulative layer (e.g., glass layer). In general, the capacitive touch screen assembly may be arranged in any manner that uses a capacitive sensing structure to determine the location of a touch or a plurality of simultaneous touches. In general, the capacitance may be calculated as C=εA/d, where e is the permittivity of the sandwiched material, A is the area of the plates, d is the separation of the conductive layers, and C is the total capacitance at the location of the intersection of the upper and lower conductors (e.g., C1 . . . C6). The capacitive touch screen assembly is connected to the display assembly using an adhesive layer.

It was determined that rather than considering the display assembly and the touch screen assembly adhered together by an adhesive, as two separate components of a complete display, it is preferable to consider the interface between the display assembly and the touch screen assembly as a polarizer adhered to an insulative layer that supports a conductive layer. The insulative material performs a limited purpose of supporting the conductive layer, and thus if it could be removed, then the display may be generally thinner by the thickness of the insulative material (e.g., glass). With the insulative material being removed, then the interface between the display assembly and the touch screen assembly reduces to the combination of a polarizer and a conductive layer. The polarizer provides the desirable polarization for the display assembly and the conductive layer provides the desirable conductive material for the touch screen assembly. The combination of the polarizer and the conductive layer is preferably replaced with a conductive linear polarizer, such as a wire grid polarizer. The wire grid polarizer provides the desirable polarization for the display assembly. The wire grid polarizer also provides the desirable conductive material for the touch screen assembly. Accordingly, preferably the polarizer, adhesive, insulative material (e.g., glass), and conductive material (e.g., ITO) are replaced by a wire grid polarizer, which tends to reduce the thickness of the display, tends to decrease the complexity of the display, and tends to increase the brightness of the display. It is to be understood that additional layers may be included, as desired. Also, it is to be understood that fewer layers may be included, as desired. It is to be understood that the conductive linear polarizer may be positioned at any suitable location forward of the liquid crystal material and rearward of the insulation of the touch sensor material.

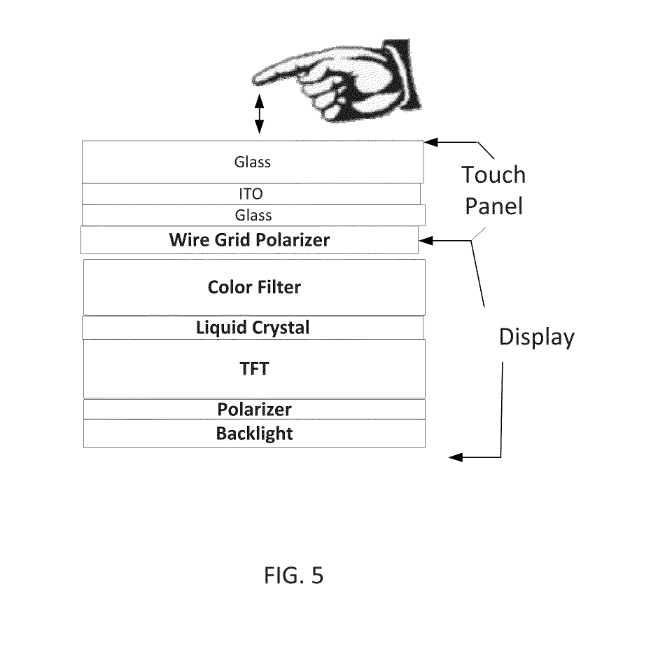

Referring to FIG. 5, a modified projective capacitive touch screen may include a series of components, including a wire grid polarizer. The display itself may include a combination of a backlight, a polarizer, a thin film transistor array, a liquid crystal layer, a color filter layer, and a wire grid polarizer. The result of which is a display assembly suitable to display images. A capacitive touch screen assembly may include a wire grid polarizer, an insulative layer (e.g., glass layer), a conductive layer (e.g., indium tin oxide), and an insulative layer (e.g., glass layer). In general, color filters may be included at any suitable location within the display assembly and/or the touch screen assembly. In general, the capacitive touch screen assembly may be arranged in any manner that uses a capacitive sensing structure to determine the location of a touch or a plurality of simultaneous touches.

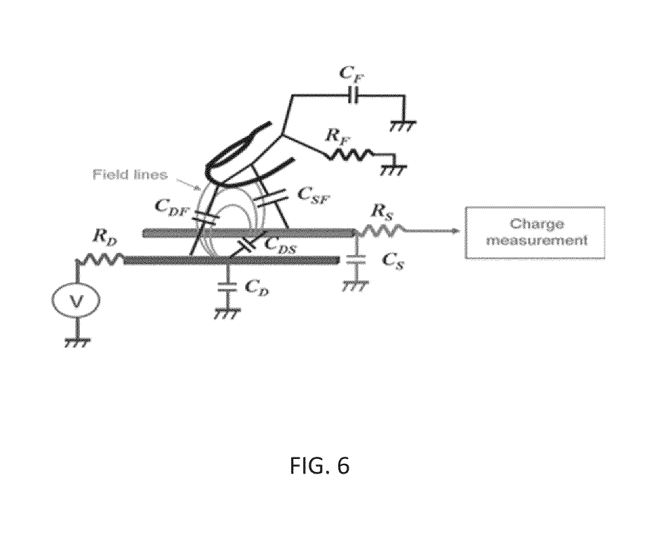

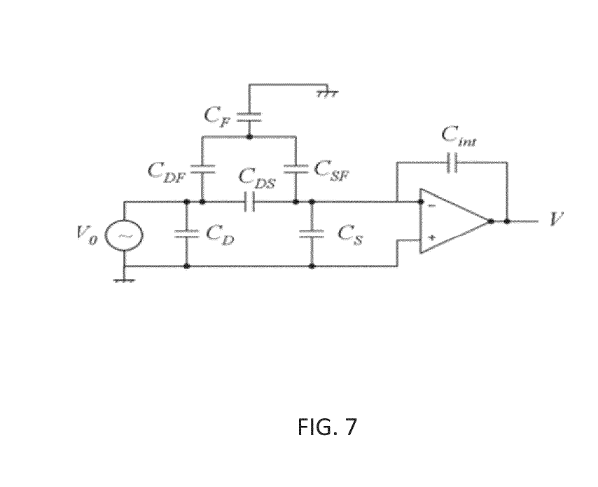

Referring to FIG. 6 and FIG. 7, an equivalent circuit is shown for the display illustrated in FIG. 5. The display may respond faster using the wire grid polarizer since the RC time constant is reduced. In this manner the sampling rate may be increased accordingly, if desired. Moreover, the power required for the display may likewise be reduced. Further, the conductive wire grid polarizer may be used with other touch screen structures, as desired.

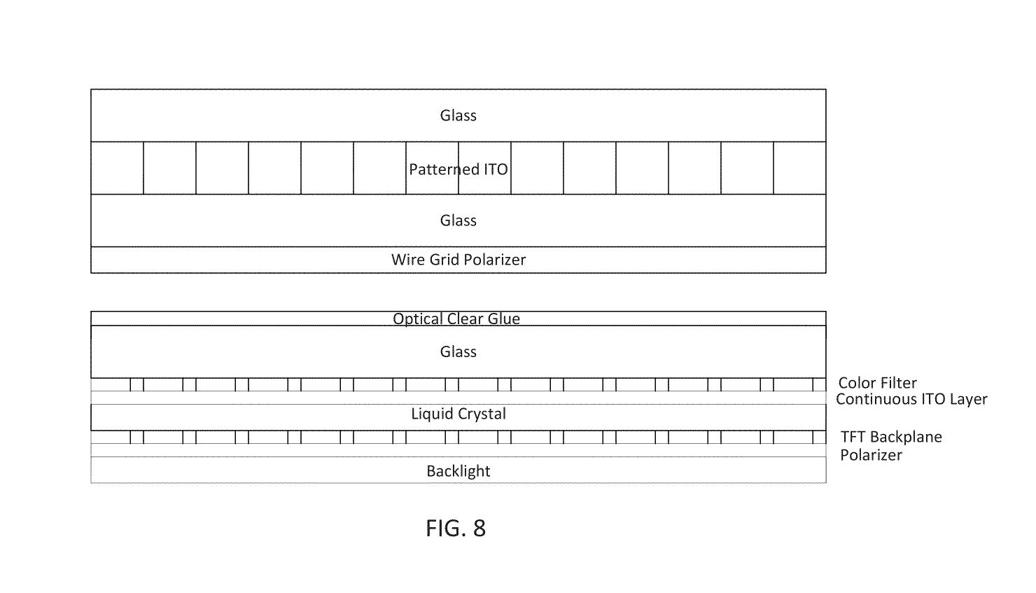

Referring to FIG. 8, another structural arrangement for including the linear conductive polarizer (e.g., the wire grid polarizer) is to include the wire grid polarizer as the lower layer of the touch screen assembly, which is then attached or otherwise adhered, to the display assembly. The display assembly of FIG. 8 is shown together with a color filter array.

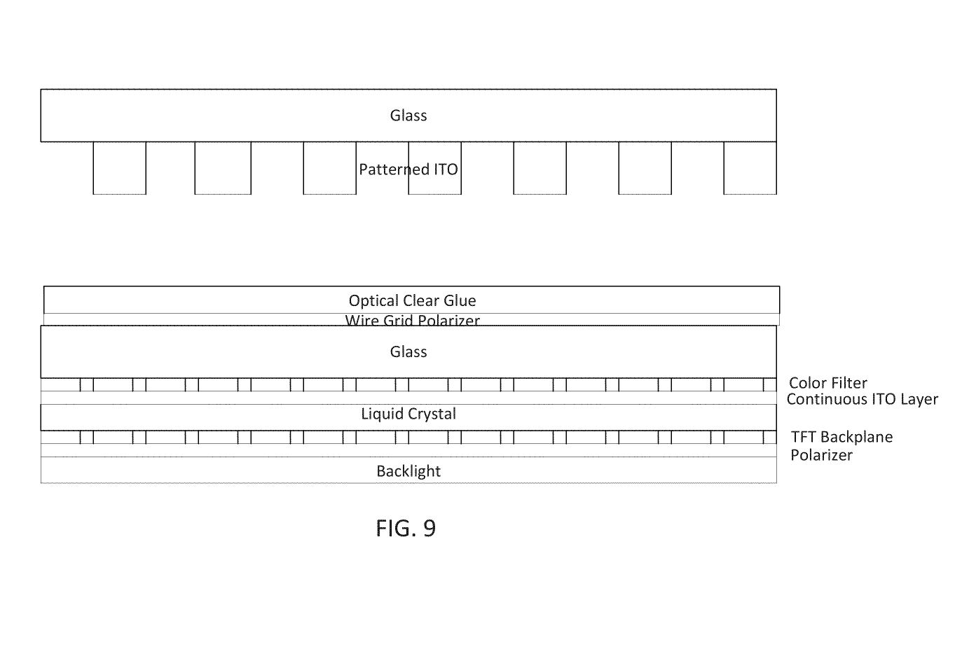

Referring to FIG. 9, another structural arrangement for including the linear conductive polarizer (e.g., the wire grid polarizer) is to include the wire grid polarizer as part of the color filter assembly (e.g., supported by the insulator of the color filter array). This manner of assembly eliminates the need for one piece of glass that was on the touch sensor by placing the wire grid polarizer onto the color filter glass. The glue layer may be adjusted as desired, such as its thickness to change the “d” for the capacitance and/or material selection to change the “ε” for the capacitance. In some cases, the glass may be replaced by a glue layer as the insulator layer, further reducing the thickness of the display.

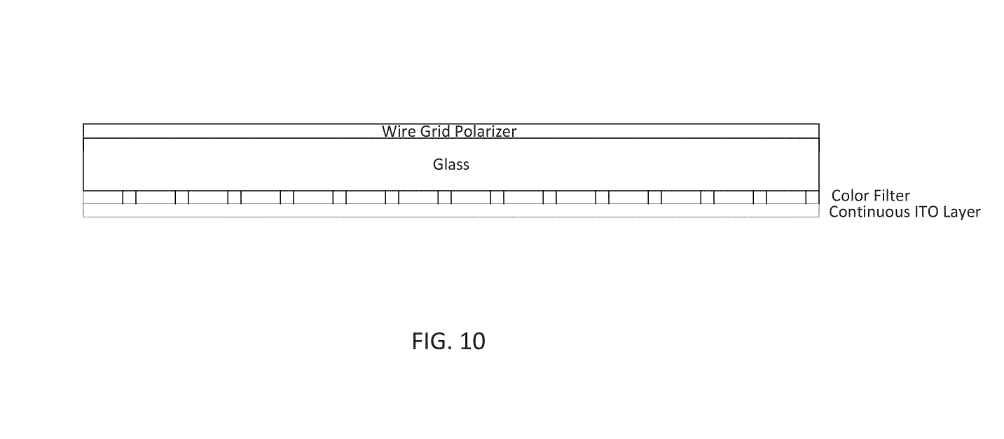

Referring to FIG. 10, with the structure illustrated in FIG. 9, the color filter assembly may be constructed as a unit apart from the display assembly and/or the touch panel assembly. In this manner, the construction of the display may be simplified.

The conductive material of the linear conductive polarizer may include a dielectric layer thereon (such as a portion thereof), such as a coating, this is at least partially absorptive. Without the dielectric layer the display may tend to be generally reflective, such that a viewer can readily observe their reflection in the display. With the dielectric layer the display may tend to be generally less reflective, such that a viewer can't as readily observe their reflection in the display.

The dielectric material may be placed on top of the conductive layer and/or it may also be placed between the elongate conductive members of the conductive layer and/or between the conductive members and the substrate (e.g., glass). Therefore, the absorptive coating (or otherwise any coating in general) may be on top of a conductive layer and the conductive layer is on top of the substrate (e.g., glass). In another embodiment, the conductive members may be located on top of a patterned absorptive coating (e.g., the patterned absorptive coating may have a substantially similar pattern to the conductive members) with the patterned absorptive coating being on top of the substrate (e.g., glass).

In another embodiment, the touch screen assembly may include a direct pattern window and/or a sensor on lens structure. In this embodiment the conductive layer (e.g., ITO) may be deposited directly underneath the dielectric layer (e.g., glass) as the touch panel for the display assembly. To this combination may be included together with the display assembly.

The absorption coating and/or film may be positioned on wire grid ribs, so that the absorption coating (or any other coating) is on top of a rib and the rib is on top of the substrate (e.g., glass). However, the absorption coating and/or film may also be positioned between the rib (e.g., aluminum) and the substrate (e.g., glass), if desired. In this case, the ribs may be on top of a patterned absorption coating (e.g., the coating matches the footprint of the aluminum ribs), and the patterned coating is on top of the substrate.

In another embodiment, the display together with the conductive material of the linear conductive polarizer may use a change in the capacitance to locate the horizontal and/or vertical position of the touch. For example, with a set of lines of the conductive material of the linear polarizer extending in the “X” direction, the “Y” direction may be determined by the change in the capacitance between the respective lines. For example, with a set of lines of the conductive material of the linear polarizer extending in the “Y” direction, the “X” direction may be determined by the change in the capacitance between the respective lines. In either case, the relative position along the length of the set of lines of the conductive material of the linear polarizer may be determined using another technique. For example, a change in the voltage drop (or other electrical property) along one or more of the lines may be used to locate the respective position along the line.

It is often desirable to use micron spaced wires (e.g., 2-3 um range spacing, or 1-5 um range, or 0.5 to 10 um range) to replace the ITO to simplify the construction of the display while also tending to increase the optical transmission of the display. This micron spaced wires may also be used as a continuous layer for a ground plane and/or patterned to provide other characteristics.

In general terms, the spacing (i.e., periodicity) of the wire grid polarizer should be less than the wavelength of light that one wants to polarize. The rib is typically made of an electrically conductive material, for example, gold or aluminum. The smaller the period of the wires the shorter wavelength the wire grid polarizer can affect. The height and duty cycle of the wires will affect the extinction ratio and transmission of the intensity of light that is incident to the polarizer. Also, there is an inverse relationship between the optical efficiency (i.e. optical transmission) versus the extinction ratio or contrast the polarizer can provide.

For visible light with wavelengths ranging from 400 nm to 700 nm, the range of the wire grid periodicity should be between 80 nm and 200 nm. The height of the ribs should range from generally 10 nm to generally 300 nm, with the preferred height is in the range of 40 nm to 200 nm.

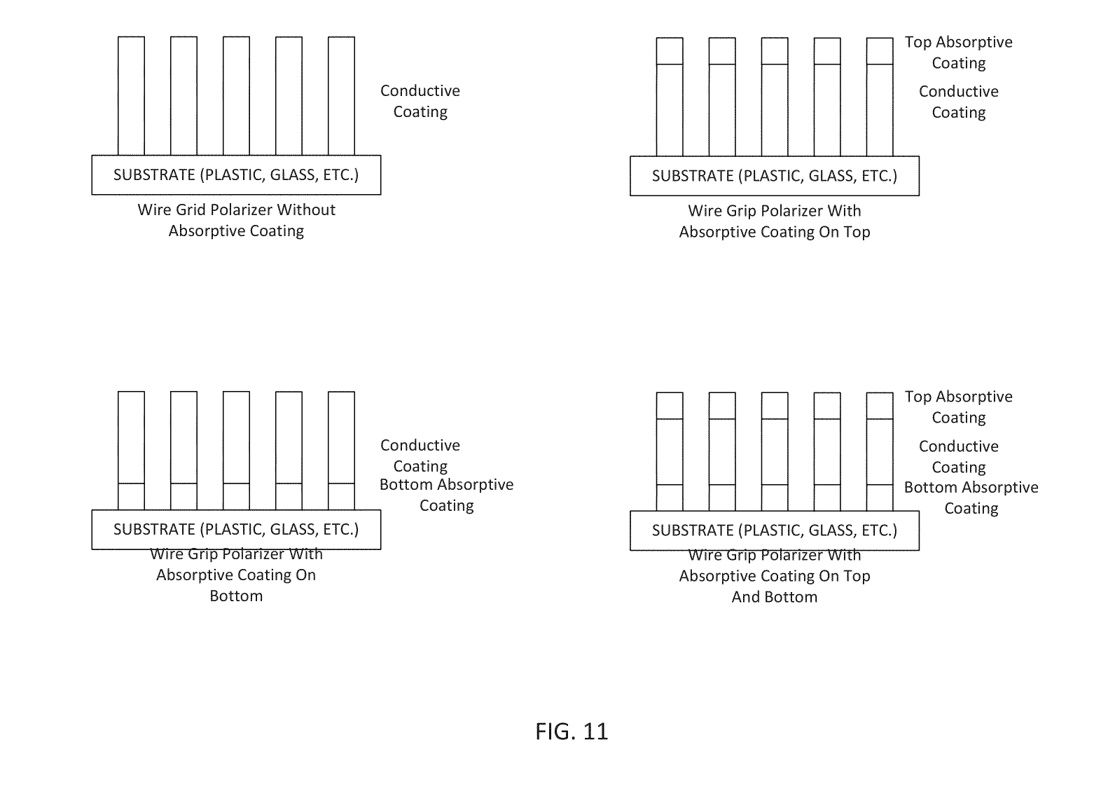

A typical wire grid polarizer will transmit one polarization state while reflecting the orthogonal polarization state of light. There is a small percent of light that the conductive wire grid material will absorb. In some cases it would be desirable to have even less reflected light. In this case, a film may be deposited on the wire grid polarizer that will act to reduce the reflected light. The absorption film may be formed in any suitable manner, such as for example, using dielectric thin films to form an interference coating that will substantially eliminate the reflected light through a destructive optical interference, as illustrated in FIG. 11.

In some cases it might be desirable to deposit a material in between the wires to “fill” in the space. Some material including SiO2 (Silicon Dioxide) or TiO2 (Tungsten Oxide) that is used to fill the space may act to improve the optical performance by acting as an index matching layer to subsequent materials that the polarize may be attached to.

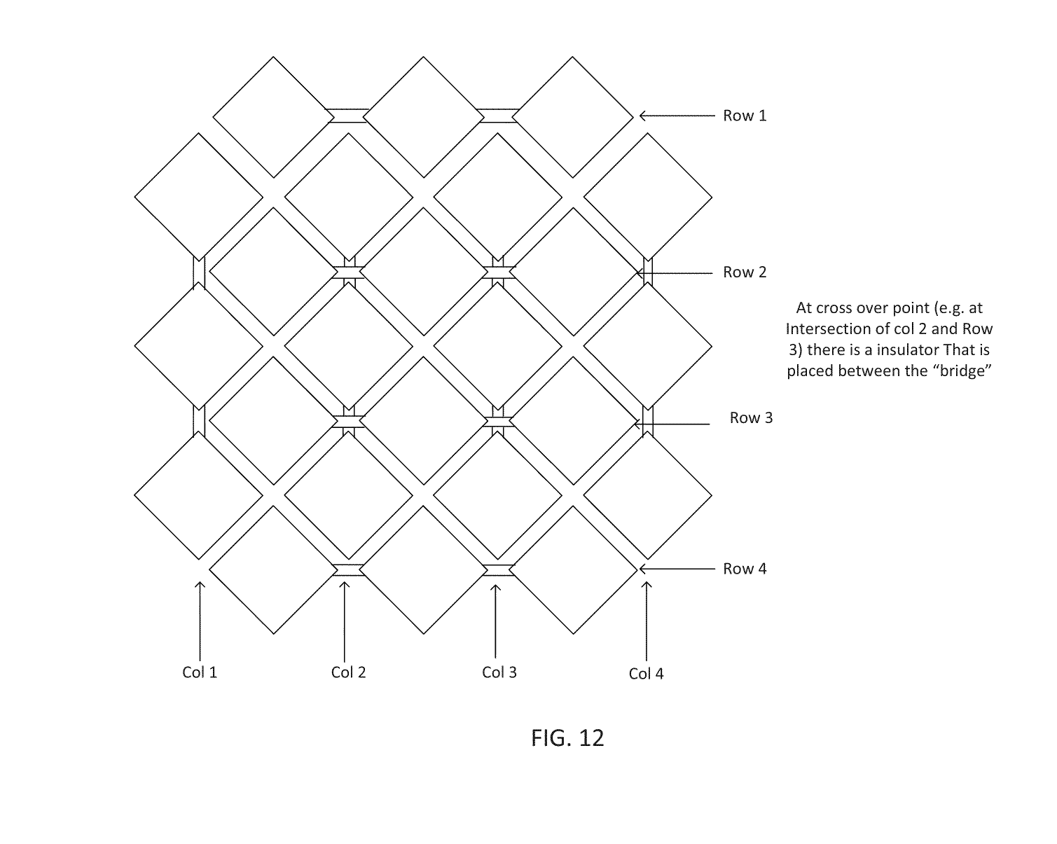

In some cases, the display may include a “one glass” architecture where the cathode and anode are co-located on the same piece of glass. Referring to FIG. 12, one implementation uses diamond shaped anode and cathodes (on the same side of the glass) together with “electrical bridges” that connect adjacent diamonds to each other. This technique increases the processing requirements for fabrication and also alignment issues tend to result in a yield loss especially with increased display size.

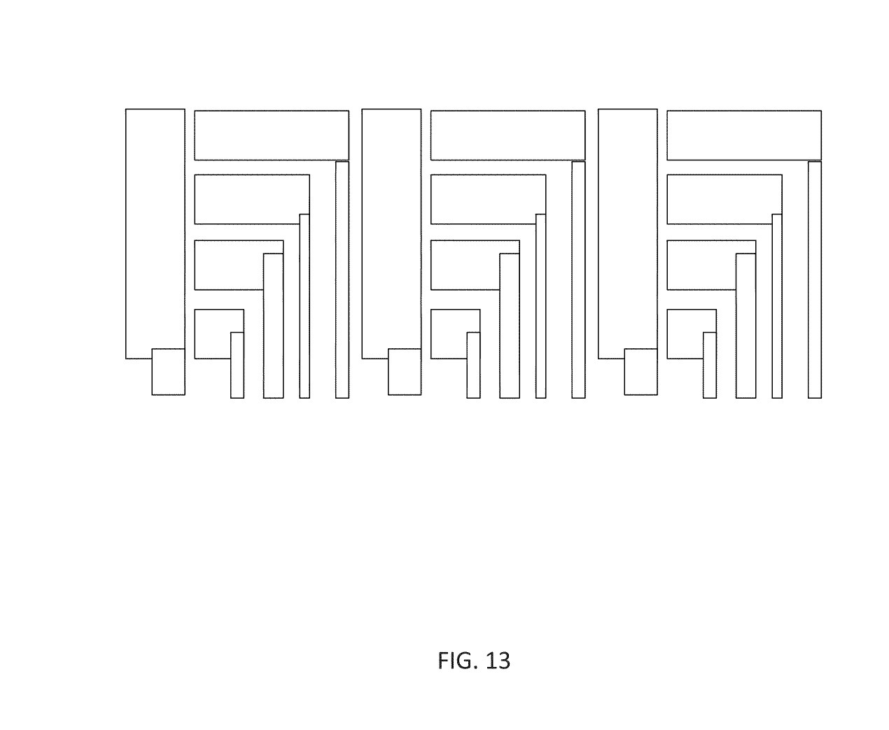

Referring to FIG. 13, another design uses coplanar pads that do not “cross over” any other electrical wires. This design may need to have contact electrical lines connect to each pad requiring more space between the sense line and the signal line as the touch sensor increases in size.

The use of the wire grid polarizer, rather than the “one glass” architecture, has improved yield characteristics and manufacturing simplicity.

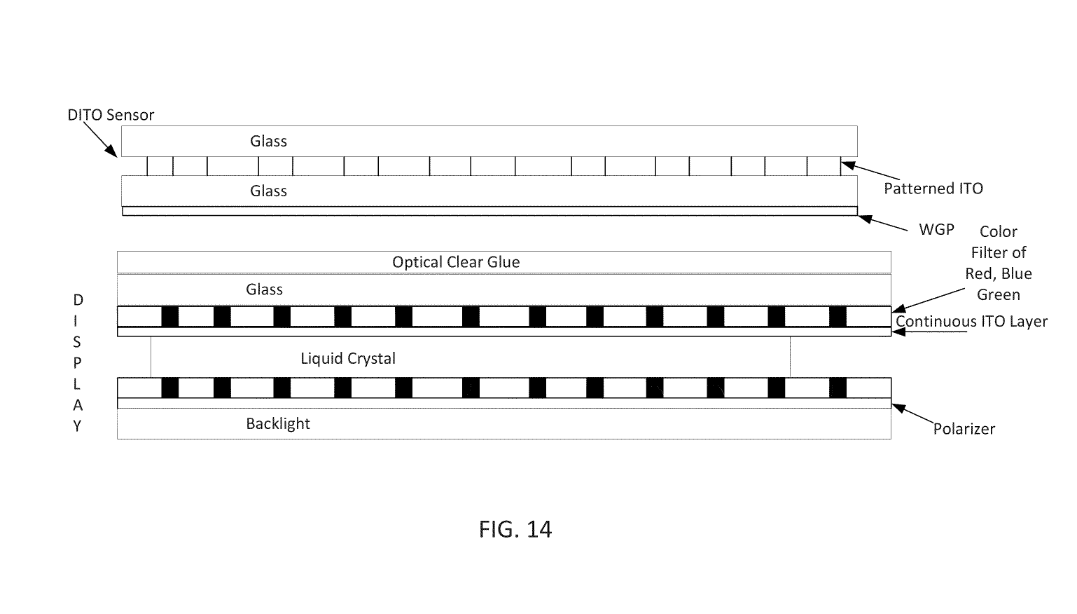

As previously described, the wire grid polarizer may be located at any suitable position. Referring to FIG. 14, for example, the wire grid polarizer may be positioned as a standalone sensor (e.g., dual sided ITO sensor) which is then laminated to the upper portion of a liquid crystal display. The wire grid polarizer is aligned with the top polarizer of the display. Also, the wire grid polarizer may replace the top polarizer of the display to increase the optical transmission of the display. In addition, the positions of the patterned Ito with the wire grid polarizer may be switched, if desired, where the patterned ITO would be the closest to the display and the wire grid polarizer would be the closest to the viewer. Preferably, the wire grid polarizer takes the place of the top most polarizer in the display.

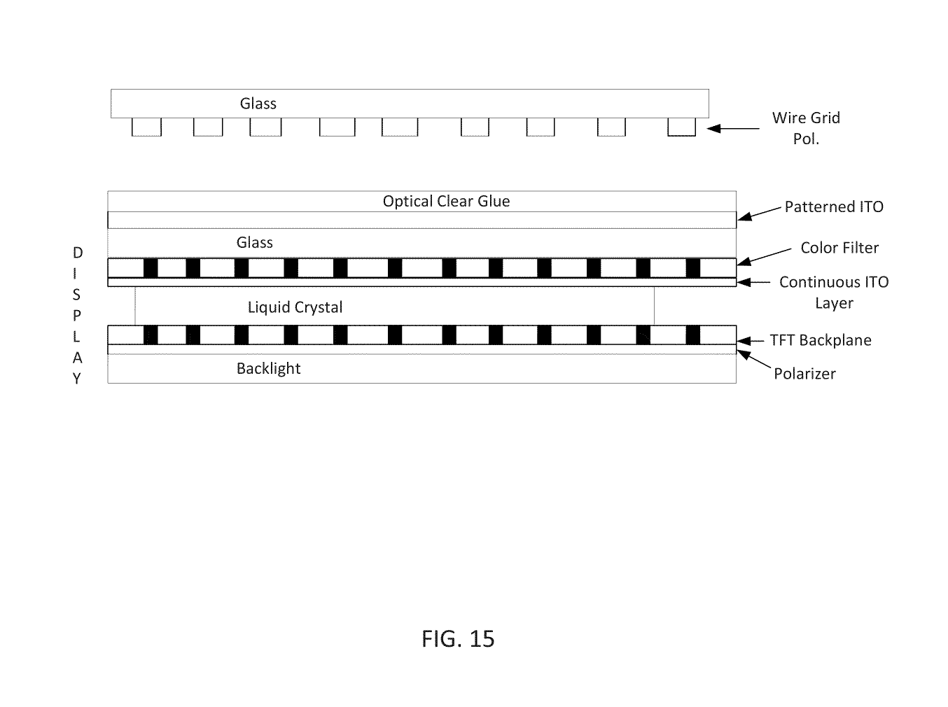

Referring to FIG. 15, the wire grid polarizer may be deposited and/or laminated to the color filter glass. In this case the glass substrate may be eliminated and the ITO (or other wire like technology) is deposited on the bottom of the cover glass and/or lens. The capacitance value of the system node sensor may be controlled by the surface area of the pad, the dielectric constant of the adhesive, and/or the thickness of the adhesive. Similarly, the placement of the patterned ITO (or other) and the wire grid polarizer may be interchanged, if desired.

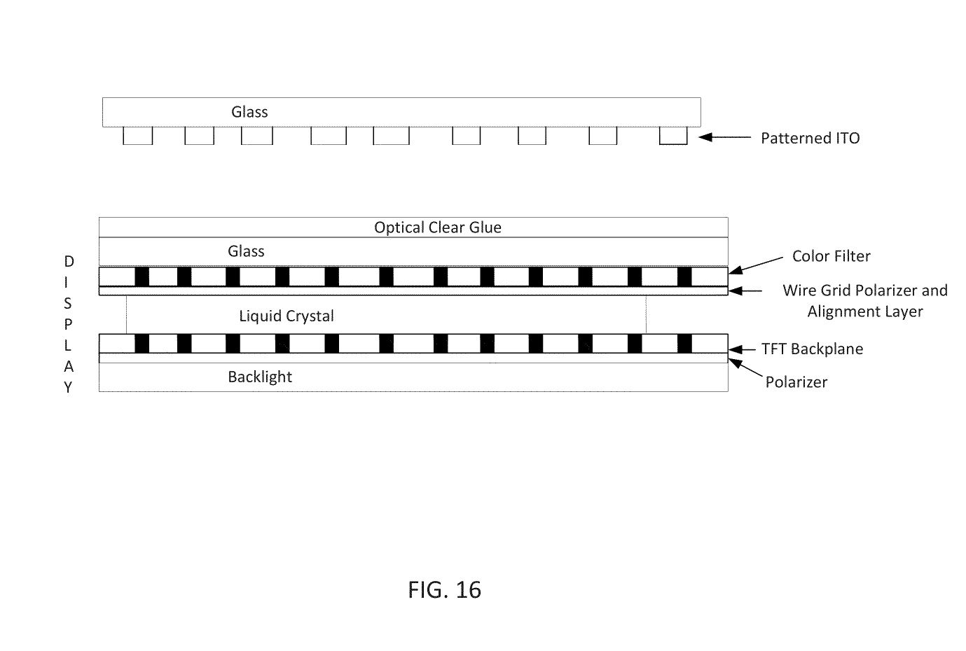

Referring to FIG. 16, the wire grid polarizer may be deposited inside the liquid crystal module and this layer may also act as the alignment layer for the liquid crystal panel. The drive electronics sample timing may be selected to avoid sampling for a “touch event” while writing the image information. The sampling time for the touch event may be relatively short and the display may, if desired, “sense” a touch event during the dead time when the display pixels are doing the read/write function.

The wire grid polarizer may be constructed using any suitable technique. One technique is to use semiconductor photolithography techniques and/or deposited on a plastic roll.

In general, the sampling for the touch effects for the wire grid polarizer may be interlaced between the timing sequence of the refresh rate for each image plane for the display.

It is to be understood that the claims are not limited to the precise configuration and components illustrated above. Various modifications, changes and variations may be made in the arrangement, operation and details of the systems, methods, and apparatus described herein without departing from the scope of the claims.

I/we claim:

1. A liquid crystal display comprising:
(a) a light valve that modifies the transmittance of light through said light valve; and
(b) a linear polarizer.

2. The liquid crystal display of claim 1 further comprising a backlight that provides light to said light valve.

3. The liquid crystal display of claim 1 wherein said linear polarizer includes a wire grid polarizer.

4. The liquid crystal display of claim 3 wherein said wire grid polarizer includes an array of substantially parallel conductive wires location substantially in a plane.

5. The liquid crystal display of claim 4 wherein said plane is substantially co-planar with a plane of said light valve.

6. The liquid crystal display of claim 5 wherein said parallel conductive wires have a width of generally 15 nm to generally 150 nm.

7. The liquid crystal display of claim 5 wherein said parallel conductive wires have a width of generally 25 nm to generally 75 nm.

8. The liquid crystal display of claim 5 wherein said parallel conductive wires have a width of generally 50 nm.

9. The liquid crystal display of claim 5 wherein said parallel conductive wires have a spacing between adjacent ones of generally 50 nm.

10. The liquid crystal display of claim 5 wherein said parallel conductive wires have a spacing between adjacent ones of generally 25 nm to generally 75 nm.

11. The liquid crystal display of claim 5 wherein said parallel conductive wires have a spacing between adjacent ones of generally 15 nm to 150 nm.

12. The liquid crystal display of claim 5 wherein said parallel conductive wires have a center-to-center spacing between adjacent ones of generally 100 nm.

13. The liquid crystal display of claim 5 wherein said parallel conductive wires have a center-to-center spacing between adjacent ones of generally 50 nm to 150 nm.

14. The liquid crystal display of claim 5 wherein said parallel conductive wires have a center-to-center spacing between adjacent ones of generally 100 nm to generally 225 nm.

15. The liquid crystal display of claim 5 wherein said parallel conductive wires have a center-to-center spacing between adjacent ones of generally 25 nm to 125 nm.

16. The liquid crystal display of claim 5 wherein said parallel conductive wires have a height generally 120 nm to 140 nm.

17. The liquid crystal display of claim 5 wherein said parallel conductive wires have a height generally 50 nm to 250 nm.

18. The liquid crystal display of claim 5 wherein at least one of (1) a height, (2) a center-to-center spacing, and (3) a spacing between adjacent ones is different for different regions of said display.

19. The liquid crystal display of claim 1 wherein liquid crystal display is free from including another polarizer between said linear polarizer and said light valve.
